(19) United States
(12) Patent Application Publication
(10) Pub. No.: US 2003/0223130 A1
(43) Pub. Date: Dec. 4, 2003

(54) Optical lenses having guiding surfaces

(76) Inventor: Yeo-Chih Huang, Taichung City (TW)

Correspondence Address: Hart, Baxley, Daniels & Holton, Fifth Floor, 59 John Street, New York, NY, 10038, US

(21) Appl. No.: 10/161,173

(22) Filed: Jun. 4, 2002

(51) Int. Cl. G02B 9/00; G02B 7/02

(52) U.S. Cl. 359/796

(57) ABSTRACT

An assembly of optical lenses includes a first lens and a second lens, wherein the two lenses each have a concave surface and the two respective concave surfaces face with each other. The second lens has a contact surface and a separation surface respectively defined in an outer periphery of the concave surface. The separation surface is located closer to a center of the second concave surface than the contact surface. The concave surface of the first lens is engaged with the contact surface. The size of the contact surface is the same as the centering wheel so as to reduce the change resulted from machining between the two lenses.

### FIELD OF THE INVENTION

The present invention relates to an optical lens that has contact surface so that the distance between two optical lenses can be precisely controlled.

### BACKGROUND OF THE INVENTION

A conventional engagement between two lenses 101 and 102 is shown in FIG. 1 and the two respectively concave surface of the two lenses 101, 102 face with each other. The second lens 102 has contact surfaces 11 on which the first lens 101 is engaged. By controlling the sagitta, the distance between the two lenses 101, 102 can be controlled to a desired distance. However, when the second lens 102 is proceeded with centering process, if the sagitta increases Δd1, the diameter øD of the contact surfaces and this forces the side height d2 increases Δd2. The final distance d between the two lenses 101, 102 becomes Δd=Δd1+Δd2, and which is larger than Δd1. In other words, the change of the distance d between the two lenses 101, 102 will be larger than d1 which is controlled by machining processes.

### SUMMARY OF THE INVENTION

In accordance with one aspect of the present invention, there is provided an assembly of optical lenses which comprises a first lens and a second lens. The first lens has a first concave surface which faces a second concave surface of the second lens. The second lens has a contact surface and a separation surface respectively defined in an outer periphery of the second concave surface. The separation surface is located closer to a center of the second concave surface than the contact surface second lens. The concave surface of the first lens is engaged with the contact surface.

The primary object of the present invention is to provide a contact surface defined in an outer periphery of a concave surface of one of two lenses and the other lens is engaged with the contact surface. The size of the contact surface is the same as the centering wheel so as to reduce the change resulted from machining between the two lenses.

The present invention will become more obvious from the following description when taken in connection with the accompanying drawings which show, for purposes of illustration only, two preferred embodiments in accordance with the present invention.

### BRIEF DESCRIPTION OF THE DRAWINGS

FIG. 1 is a cross sectional view to show two conventional lenses engaged with each other;

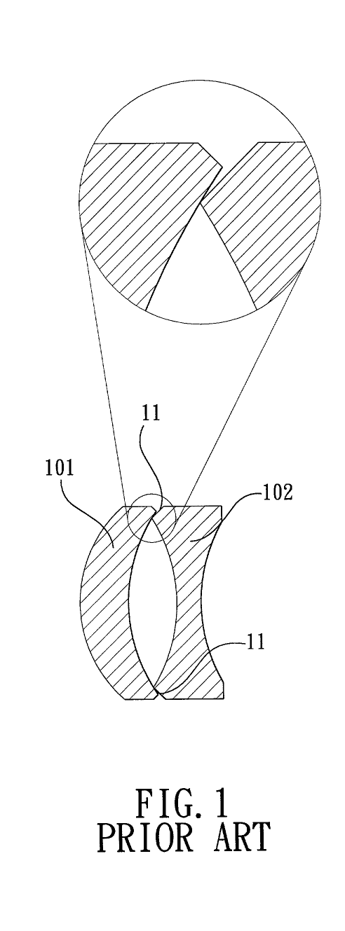

FIG. 2 is a cross sectional view to show two lenses of the present invention engaged with each other, and

FIG. 3 is a cross sectional view to show another embodiment of two lenses of the present invention engaged with each other.

### DETAILED DESCRIPTION OF THE PREFERRED EMBODIMENTS

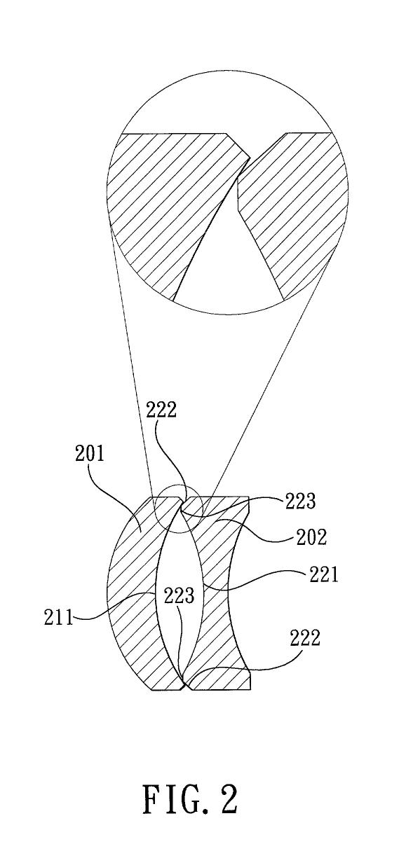

Referring to FIG. 2, the assembly of optical lenses of the present invention comprises a first lens 201 and a second lens 202, both of which are glass lenses. The first lens 201 has a first concave surface 221 which faces a second concave surface 211 of the second lens 202. The second lens 202 has a contact surface 222 and a separation surface 223 respectively defined in an outer periphery of the second concave surface 211. The separation surface 223 is located closer to a center of the second concave surface 211 than the contact surface 222. A protrusion corner is defined between the contact surface 222 and the separation surface 223. The first concave surface 221 of the first lens 201 is engaged with the contact surface 222. It is to be noted that the size of the contact surface 222 is the same as the centering wheel (not shown) so as to reduce the change resulted from machining between the two lenses 201, 202.

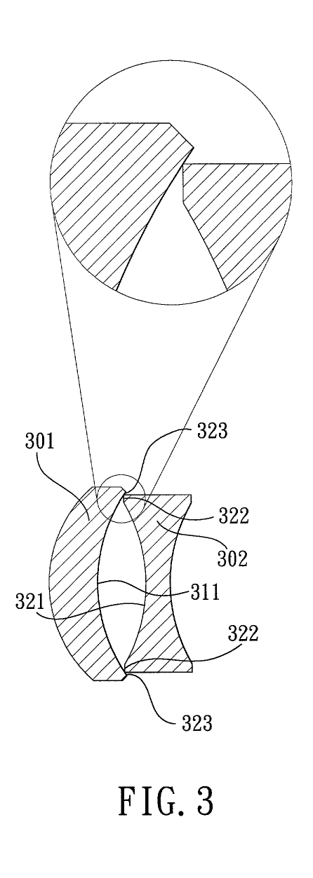

FIG. 3 shows another embodiment of the present invention, wherein the first lens 301 has a first concave surface 311 which faces a second concave surface 321 of the second lens 302. The second lens 302 has a contact edge 323 and a separation surface 322 is connected to the contact edge 323. The separation surface 322 is located closer to a center of the second concave surface 321 than the contact edge 323. The first concave surface 311 of the first lens 301 is engaged with the contact edge 323. The advantage of the embodiment is that the centering wheel is not manufactured according to the diameter of the contact edge 323 so that the centering wheel is easily to make. The second concave surface 321 has a larger curvature than that of the first concave surface 311. By this way, the amount of change of the contact surface of the centering wheel is reduced so as to simplify the processes of manufacturing.

The first lens is engaged with the contact surface or edge which is located at an outer periphery of the second concave surface so that the distance between the two lenses can be precisely controlled.

While we have shown and described the embodiment in accordance with the present invention, it should be clear to those skilled in the art that further embodiments may be made without departing from the scope of the present invention.

What is claimed is:

1. An assembly of optical lenses, comprising:
a first lens and a second lens, said first lens having a first concave surface which faces a second concave surface of said second lens, said second lens having a contact surface defined in an outer periphery of said second concave surface, said first concave surface of said first lens engaged with said contact surface.

2. The assembly as claimed in claim 1 wherein a separation surface is connected to said contact surface, said separation surface located closer to a center of said second concave surface than said contact surface, a protrusion corner defined between said contact surface and said separation surface.

3. The assembly as claimed in claim 1 wherein said contact surface is an edge.
